(19) United States
(12) Patent Application Publication
(10) Pub. No.: US 2014/0251795 A1
(43) Pub. Date: Sep. 11, 2014

(54) MANUFACTURING METHOD OF CATHODE CATALYST AND OZONE-GENERATING DEVICE

(71) Applicant: CASHIDO CORPORATION, Miaoli County (TW)

(72) Inventors: SHIH-CHANG CHEN, HSINCHU COUNTY (TW); SYUAN-HONG CHEN, MIAOLI COUNTY (TW); LIANG-CHIEN CHENG, KAOHSIUNG CITY (TW); RU-SHI LIU, NEW TAIPEI CITY (TW); I-CHIAO LIN, TAIPEI CITY (TW); CHUN-LUNG CHIU, HSINCHU COUNTY (TW); LING-HUI LU, MIAOLI COUNTY (TW); HSIU-LI WEN, MIAOLI COUNTY (TW); CHIEN-MIN SUNG, NEW TAIPEI CITY (TW)

(73) Assignee: CASHIDO CORPORATION, MIAOLI COUNTY (TW)

(21) Appl. No.: 13/787,915

(22) Filed: Mar. 7, 2013

(51) Int. Cl. B01J 27/24; C25B 1/13; C25B 11/04; C25B 9/10

(52) U.S. Cl. CPC B01J 27/24; C25B 9/10; C25B 1/13; C25B 11/0489
USPC 204/252; 502/180

(57) ABSTRACT

The instant disclosure relates to a manufacturing method of cathode catalyst, comprising the following steps. Initially, mix an organic medium with an iron-based starting material and a nitrogen-based starting material to form a mixture. Followed by adding a carbon material to the mixture and subsequently executing a heating process to form a solid-state precursor. Then mill the solid-state precursor to form a precursory powder. Successively, calcinate the precursory powder in the presence of NH₃ to form a cathode catalyst. The cathode catalyst can reduce the activation energy of hydrogen ion reacting with oxygen to make water. The instant disclosure further provides an ozone-generating device.

### BACKGROUND OF THE INVENTION

1. Field of the Invention

The instant disclosure relates to a cathode catalyst; in particular, to a cathode catalyst which is applied with an ozone generating device for catalyzing hydrogen ions generated from an anode to react and generate water and preventing production of hydrogen gas.

2. Description of Related Art

Ozone is known as a fairly powerful natural oxidizing agent, whose oxidizing power is 3000 times stronger than chloride, and unlike chloride which will remains in the environment for a long period of time, resulting in the rapid and extended use of ozone in various industries.

Presently, common ozone manufacturing methods include ultraviolet light, Corona discharge method and electrolytic ozone generation, etc. Of the three methods, ultraviolent light and Corona discharge method are commonly applied in the industry and household sector with deficiencies such as relatively high energy consumption, complex system composition, high production cost, and requiring ozone gas to dissolve in liquid water, therefore, the rise of water electrolytic ozone generating technology.

In general, water electrolysis ozone generating devices includes a solid polymer electrolyte membrane (cation exchange membrane) and the sealed anode and cathode arranged on two sides thereof. Successively, water electrolysis reactions take place between the three phases (three phase interface), the cation exchange membrane, the electrode catalyst (such as the anode electrode catalyst of iridium, a cathode electrode catalyst using platinum-carbon catalyst), and liquid phase for generating ozone from the anode and hydrogen gas from the cathode.

However, during electrolysis, the hydrogen gas generated from the three phase interface among cathode catalyst, cation exchange membrane and water will permeate through the cation exchange membrane, reach the cathode, mix with oxygen, and outwardly discharge via the pressure inside bubbles as a driving force.

According to the Young-Laplace equation (P_{g}−P_{L}=2γ/r, where P_{g}: bubble internal pressure; P_{L}: liquid pressure; y: the surface tension of the liquid; r: radius of the bubble), when liquid pressure is fixed, the smaller the radius of the bubble, the larger the internal pressure therein, which correspondingly leads to a decline in the ozone purity or the current efficiency of the gas generated (i.e. degradation in the performance of a water ozone generating device).

Moreover, during the generation of ozone, oxygen, and hydrogen in the ozone generating device, since hydrogen gas move towards the cathode (4.65% volume of an ozone, oxygen, and hydrogen gas mixture is hydrogen gas), the lower explosion limit of hydrogen might be exceeded. Particularly, when electrodes produce high concentration of gas at a relatively high current density, device safety is likely to become a concern. Moreover, the resulting hydrogen ion generated can easily lead to electrode corrosion which reduces the usable life of the electrodes.

To address the above issues, the inventor strives via associated experience and research to present the instant disclosure, which can effectively improve the limitation described above.

### SUMMARY OF THE INVENTION

The object of the instant disclosure is to provide a manufacturing method for a cathode catalyst suitable for an ozone generating device which can generate ozone for an extended period. The cathode catalyst can prevent the generation of hydrogen gas which is a safety concern, thus, increase the stability of the ozone generating device.

According to a first embodiment of the instant disclosure, the manufacturing method of the cathode catalyst comprises an iron-based starting material and a nitrogen-based starting material mixed into an organic medium, thus, forming a mixture. Then, a carbon material is added into the mixture and heat-treated to form a solid precursor. Thereafter, the solid precursor undergoes milling to form a precursor powder, and successively, the precursor powder is calcinated in the presence of ammonia to form the cathode catalyst.

According to the aforementioned cathode catalyst, the instant disclosure further provides an ozone generating device comprises a cation exchange membrane, an anode reservoir, and a cathode reservoir. The anode reservoir is arranged on a side of the cation exchange membrane and has an anode in contact with a face of the cation exchange membrane, in which the anode comprises an anode substrate and an anode catalyst layer formed on the anode substrate. The cathode reservoir is arranged on the other side of the cation exchange membrane, in which the cathode comprises a cathode substrate and a cathode catalyst layer formed on the cathode substrate. The cathode catalyst layer comprises the cathode catalyst made from the aforementioned manufacturing method.

In summary, the cathode catalyst in accordance with the embodiments of the instant disclosure comprises at least three elements: iron, nitrogen, and carbon. When the anode of the ozone generating device transforms water into ozone, the by-products, hydrogen ions, will permeate through the cation exchange membrane to the cathode. The hydrogen ions react with the cathode catalyst of the instant disclosure via an oxidation reaction to produce water, which can effectively prevent hydrogen gas generation, a safety concern, lower the possibility of hydrogen ion corrosion to electrodes, and increase safety and stability of the ozone generating device.

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1 is a cross-sectional view illustrating the ozone generating device of the instant disclosure;

FIG. 2 is a flow diagram illustrating the cathode catalyst manufacturing method of the instant disclosure;

FIG. 3 is an X-ray diffraction pattern graph of cathode catalysts made at different calcination temperature of the instant disclosure;

FIG. 4 is a graph of the instant disclosure illustrating the oxygen reduction reactivity with respect to cathode catalysts made at different calcination temperature;

FIG. 5 is a graph of the instant disclosure illustrating the relationships of the hydrogen peroxide generation rate and the number of electrons transferred with respect to the electric potential of cathode catalysts made at different calcination temperature; and

FIG. 6 is a graph of the instant disclosure illustrating the electric potential of three different iron-based starting materials.

### DETAILED DESCRIPTION OF THE PREFERRED EMBODIMENTS

The aforementioned illustrations and detailed descriptions are exemplarities for the purpose of further explaining the scope of the instant disclosure. Other objectives and advantages related to the instant disclosure will be illustrated in the subsequent descriptions and appended drawings.

The following is a more detailed description of the manufacturing method of an ozone generating device and a cathode catalyst according to the instant disclosure, in which the ozone generating device can consistently generate ozone for an extensive amount of time.

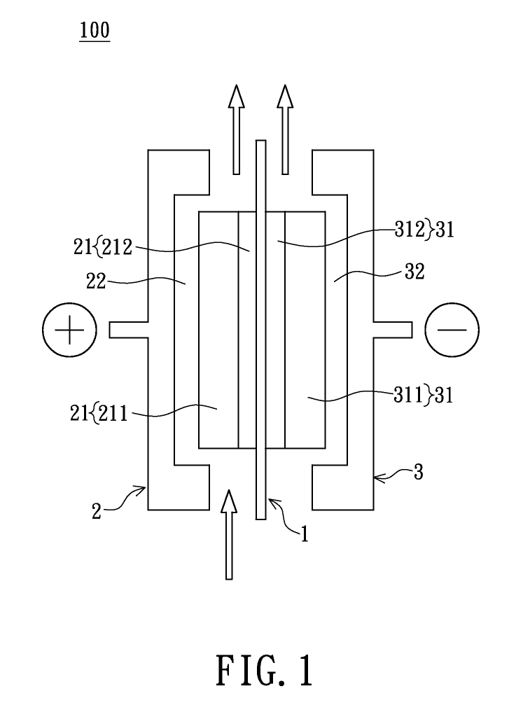

Please refer to FIG. 1 as a top view of the instant disclosure. An ozone generating device 100 comprises a cation exchange membrane 1, an anode reservoir 2, and a cathode reservoir 3. The anode reservoir 2 is arranged proximate to a side of the cation exchange membrane 1 and have an anode 21 formed on a face of the cation exchange membrane 1. Furthermore, an anode chamber 22 is defined between the anode 21 and the anode reservoir 2. The anode 21 includes an anode substrate 211 upon which an anode catalyst layer 212 is supported. The anode substrate is a conductive porous structure. Specifically, the anode catalyst layer 212 is applied on a face of the anode substrate 211 while the other face contacts the cation exchange membrane 1 for generating ozone.

The cathode reservoir 3 is arranged proximate to another side of the cation exchange membrane 1 and has a cathode 31 formed on the other face of the cation exchange membrane 1. Furthermore, a cathode chamber 32 is defined between the cathode 31 and the cathode reservoir 3. The cathode 31 includes a cathode substrate 311 upon which a cathode catalyst layer 312 is supported. Specifically, the cathode catalyst layer 312 is applied on a face of the cathode substrate 311 while the other face contacts the cation exchange membrane 1 for generating hydroxide.

In the instant embodiment, the membrane 1 is preferably a perfluorosulfonic acid cation exchange membrane which has high cation selective permeability, high chemical and thermal stability, high mechanical strength, low-electrolyte diffusion rate, and a low resistance, etc.

Proximate to an anodic portion of the cation exchange membrane 1, the anode substrate 211 is generally a structure having conductivity and corrosion resistance to antioxidants such that the gas produced can be fully released and the electrolyte can circulate adequately. For example, sheet or rolled form of carbon fiber body (carbon paper or carbon cloth) or metals such as titanium, tantalum, niobium, and zirconium as the substrate material having the form of a porous body, mesh body, fibrous body, foamed body, but not limited thereto. Furthermore, the porous body can be formed by mixing fluororesin with metal particles, in which the fluororesin is preferably polytetrafluoroethylene (PTFE). Alternatively, the porous body can be porous metal plate or a metal fiber sintered body.

The anode catalyst layer 212 may be formed on the surface of the anode substrate 211 with materials having relatively high oxygen overvoltage through a process such as electroplating, thermal decomposition, coating, hot pressing, etc. The anode catalyst layer 212 may be lead dioxide or conductive diamond.

Proximate to a cathodic portion of the cation exchange membrane 1, the cathode substrate 311 can be sheet or rolled form of carbon fiber body (carbon paper or carbon cloth) or metals such as nickel, stainless steel, and zirconium as the substrate material having the form of a porous body, mesh body, fibrous body, foamed body, but not limited thereto. More importantly, the cathode catalyst layer 312 of the instant disclosure comprises a cathode catalyst made from the following manufacturing method.

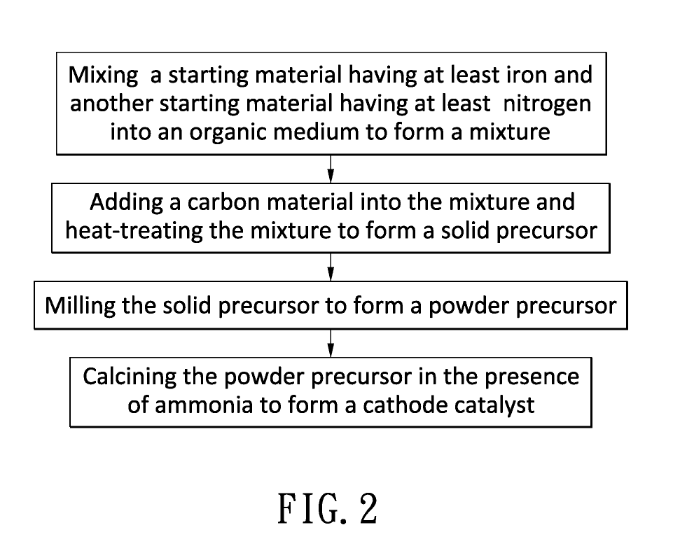

Please refer to FIG. 2 as the process flow diagram of the manufacturing method for a first embodiment of the instant disclosure. Initially, an iron-based starting material and a nitrogen-based starting material are mixed into an organic medium to form a mixture. In the instant embodiment, the iron-based starting material is ferrous acetate (Fe (C₂H₃O₂)₂) while the nitrogen-based starting material is phosphorus phenanthroline and the organic medium is ethanol. Then, ferrous acetate and phosphorus phenanthroline are mixed into ethanol at a molarity ratio of 1.7:11.1 and further homogeneously mixed for about 12 hours to form the mixture. During the mixing process, a chelate is formed by iron ions of the ferrous acetate and phosphorus phenanthroline and the mixture is then dissolved in ethanol.

Thereafter, a carbon material is added into the mixture and undergoes a heat-treating process to form a solid precursor. Specifically, the carbon material can be carbon black, graphite whiskers, amorphous carbon, activated carbon, mesoporous carbon, porous carbon fiber, carbon nanofiber, carbon nanotubes or carbon fibers. Particle size of the carbon material is less than 10 microns. Subsequently, the mixture having the carbon material is placed into an oven for the heat-treating process at a temperature between 60° C. to 80° C., and then maintained temperature for about 8 to 16 hours for removing the solvent to form the solid precursor.

Next, the solid precursor is milled into a powder precursor. During milling, the solid precursor is placed in a milling tank and undergoes milling via zirconium ball for about 2 to 4 hours to form the powder precursor.

Successively, the powder precursor is calcined in the presence of ammonia to form the cathode catalyst. During calcination, the power precursor is placed in a high-temperature furnace in the presence of ammonia, and calcining at a temperature between 500° C. to 1000° C. for about 1 to 3 hours to form the powder form of cathode catalyst which includes at least three elements: iron, nitrogen, and carbon. Furthermore, the powder form cathode catalyst is first mixed with a resin to form a paste like mixture, then coated on a surface of the cathode substrate 311, and thereafter dried to form the cathode catalyst layer 312.

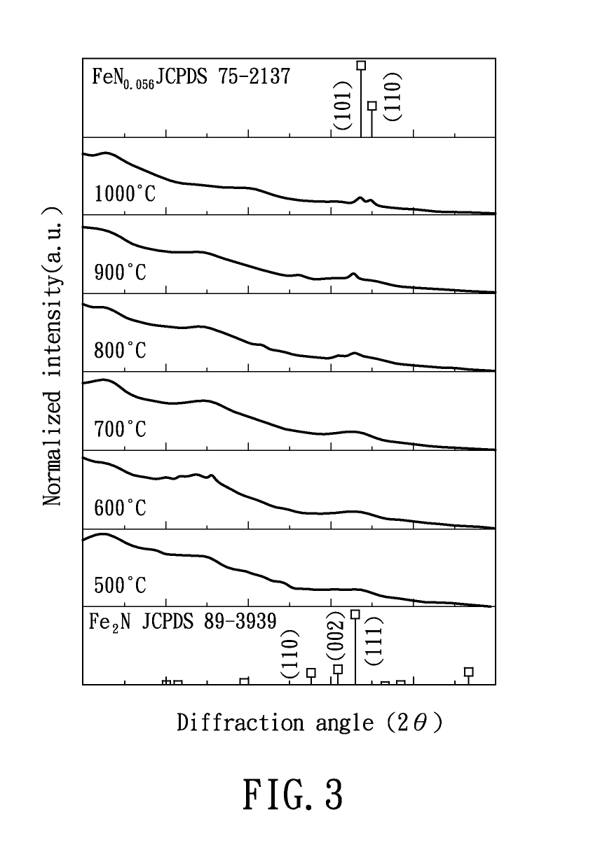

As shown in FIG. 3 is an X-ray diffraction pattern graph of cathode catalysts made at different calcination temperature specifically illustrating the crystalline phase during each process from mixing the material to milling the solid precursor into the powder precursor. As illustrated, between 500° C. to 600° C., calcinated catalysts shows no significance of Fe₂N phase growth whereas between 700° C. to 900° C., calcinated catalysts shows relatively higher significance of Fe₂N phase growth, and at around 1000° C., Fe₂N in calcinated catalysts completely transformed into FeN_{0.056}.

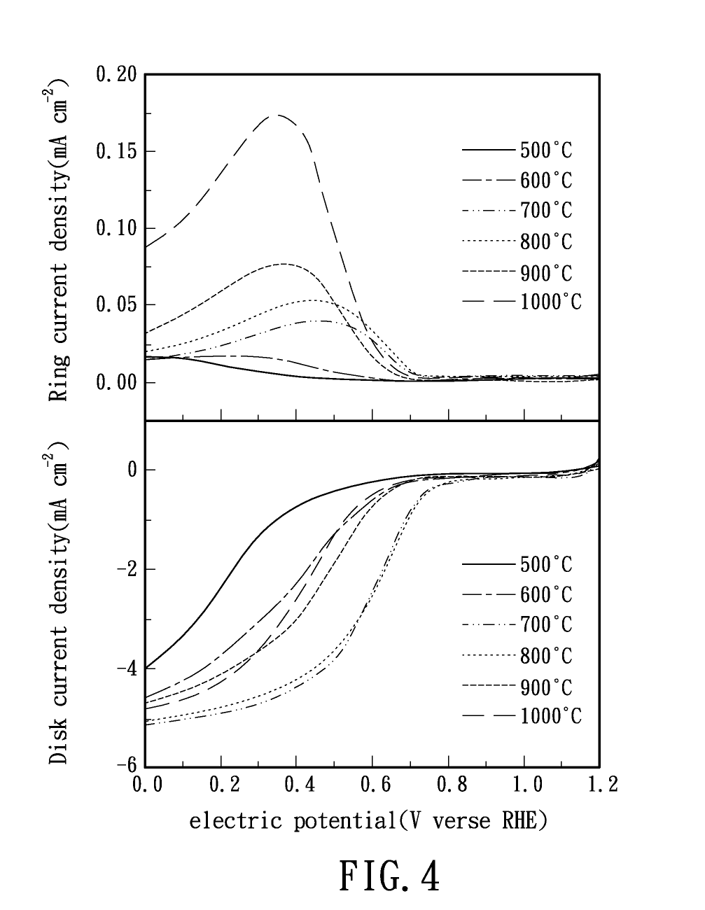

As shown in FIG. 4 is a graph of the oxygen reduction reactivity with respect to cathode catalysts made at different calcination temperature, in which the Y axis respectively shows from top to bottom the density of the ring current and the disc current. Specifically, catalysts made at different calcination temperature are formed on the disc electrode of the rotating ring-disc electrode (RRDE), and using linear voltammetry to measure the redox reaction (oxygen reduction reaction, ORP) activity in an 0.5M aqueous solution of oxygen-rich sulfuric acid.

As illustrated in figures, the half-wave potential of the cathode catalyst in the instant disclosure shifts towards the high potential as the calcination temperature rises which means that the redox reaction activity increases as the calcination temperature rises. However, when the calcination temperature exceeds 800° C., the half-wave potential will shifts towards the low potential as the calcination temperature continues to rise. In addition, catalytic activity results derived from theoretical calculations in literatures point out that the onset potential of the catalyst will determine the adsorption energy of the oxygen adsorbed on the surface of the catalyst. In other words, the lower the onset potential the higher the starting potential.

Therefore, cathode catalysts calcined at a calcination temperature between 700° C. to 800° C. not only has the highest half-wave potential, but can also effectively reduce the adsorption energy of oxygen. As a result, a temperature between 700° C. to 800° C. is the most preferably calcining temperature.

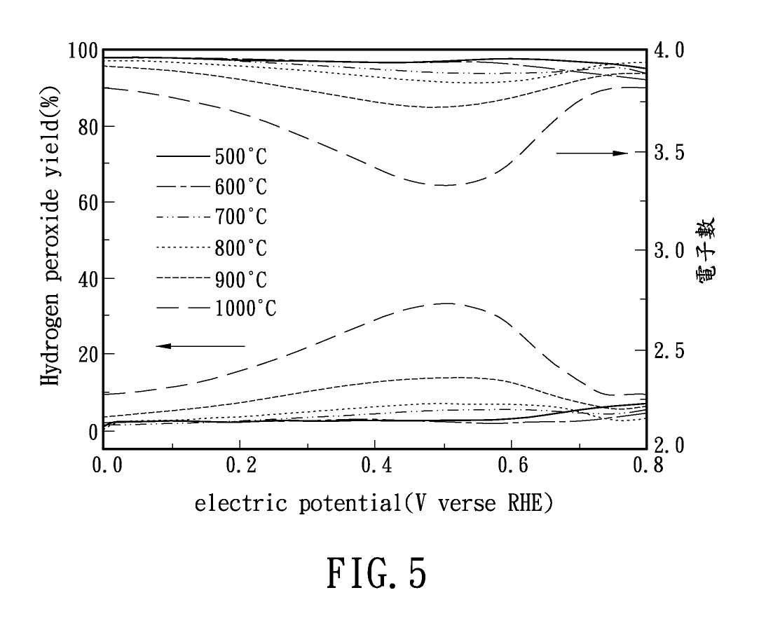

As illustrated in FIG. 5 is the graph illustrating the relationships of the hydrogen peroxide generation rate and the number of electrons transferred with respect to the electric potential of cathode catalysts made at different calcination temperature. As shown, cathode catalysts at a calcination temperature between 500° C. to 800° C. will catalyze a redox reaction path involving four electrons (as shown in chemical reaction 1 below) while the calcinated catalysts at a calcination temperature between 900° C. to 1000° C. will catalyze a redox reaction involving two electrons (as shown in chemical reaction 2 below) and resulting in higher concentrations of hydrogen peroxide.

O2+4H++4e−→2H2O (Reaction 1)

O2+2H++2e−→H2O2 (Reaction 2)

As mentioned above, the cathode catalysts of the instant disclosure includes Fe₂N, and the Fe₂N is formed on the carbon carriers which can catalyze hydrogen and oxygen ions to form water through a four-electron transfer reaction. In other words, by applying the ozone generating device 100 with the aforementioned cathode catalysts, hydrogen ions generated from the anode 21 can transform into water to prevent hydrogen gas from generating, as a result increasing the safety and stability of the ozone generating device 100. Moreover, the ozone generating device 100 may also prevent electrodes from corrosion subjected to hydrogen ions, thereby extending the usable life of electrodes.

### Second Embodiment

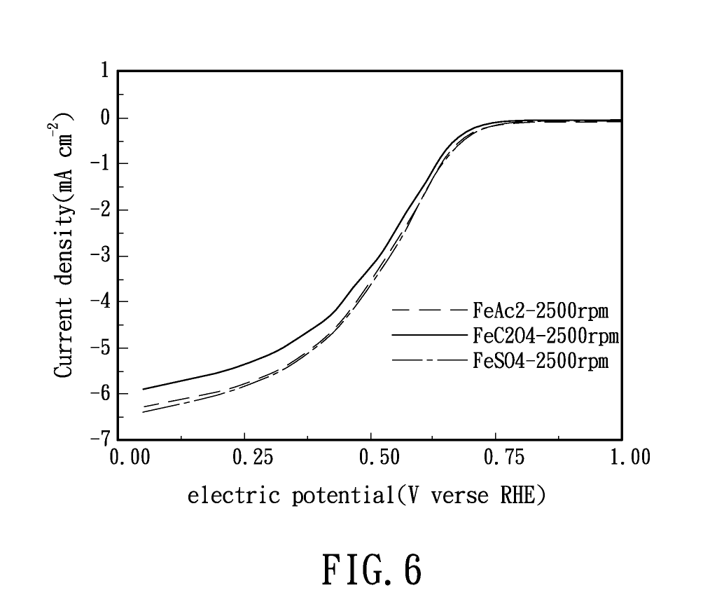

Please refer to FIG. 6 as the graph illustrating electric potentials of the three different iron-based starting materials. The iron ion activity of ferrous acetate (Fe (C₂H₃O₂)₂), ferrous sulfate (FeSO₄), and ferrous oxalate (FeC₂O₄) can be derived from the respective slope of the current density, in which the greater the slope is more preferable.

As illustrated, the three starting materials show no significant difference therebetween, therefore, the iron-based starting material can be ferrous sulfate or ferrous oxalate. Furthermore, ferrous sulfate and phosphorus phenanthroline are mixed into ethanol at a molarity ratio of 2.8: 11.1, respectively.

Moreover, ferrous oxalate and phosphorus phenanthroline are mixed into ethanol at a molarity ratio of 1.5: 11.1, respectively, to form a mixture. In addition, the organic medium can be one selected from methanol, ethanol, butanol, isopropanol, and propanol. Thereafter, continue with the remaining steps to make the cathode catalyst of the instant disclosure.

In summary, the instant embodiments of the cathode catalyst and ozone generating device have the following objectives. The aforementioned manufacturing method is simple, rapid, and lower cost than platinum and other catalysts of precious metals, therefore, of great value. Furthermore, cathode catalyst made by the aforementioned manufacturing method has 4-electron transport efficiency which can catalyze hydrogen and oxygen ions via a 4-electron transport reaction to produce water, prevent hydrogen from corroding the electrodes, and reduce the probability of the secondary reaction of a 2-electron transport to produce hydrogen peroxide. In addition, when the anode of the ozone generating device 100 transforms water into ozone gas, the by-products, hydrogen ions, will permeate through the cation exchange membrane 1 to the cathode 31 and react with the aforementioned cathode catalyst via an oxygen reaction to produce water which effectively prevent the safety concern of hydrogen gas generation, lower the possibility of hydrogen corrosion on electrodes, and increase safety and stability of the ozone generating device 100.

The figures and descriptions supra set forth illustrated the preferred embodiments of the instant disclosure; however, the characteristics of the instant disclosure are by no means restricted thereto. All changes, alternations, combinations or modifications conveniently considered by those skilled in the art are deemed to be encompassed within the scope of the instant disclosure delineated by the following claims.

What is claimed is:

1. A method for manufacturing a cathode catalyst, comprising steps of:
mixing a starting material having at least iron and another starting material having at least nitrogen into an organic medium to form a mixture;
adding a carbon material into the mixture and heat-treating the mixture to form a solid precursor;
milling the solid precursor to form a powder precursor; and
calcining the powder precursor in the presence of ammonia to form the cathode catalyst.

2. The method as recited in claim 1, wherein the starting material having at least iron is selected from the group consisting of ferrous acetate, ferrous sulfate, and ferrous oxalate and the starting material having at least nitrogen is phosphorus phenanthroline.

3. The method as recited in claim 1, wherein the organic medium is selected from the group consisting of methanol, ethanol, butanol, isopropanol, and propanol.

4. The method as recited in claim 1, wherein the starting material having at least iron and the starting material having at least nitrogen have a respective molarity ratio of about 1.5 to 2.8: 11.1 and are mixed into the organic medium.

5. The method as recited in claim 1, wherein the carbon material is selected from the group consisting of carbon black, graphite whiskers, amorphous carbon, activated carbon, mesoporous carbon, porous carbon fiber, carbon nanofiber, carbon nanotubes and carbon fibers, and heat-treated via an oven at a temperature between 60° C. to 80° C. for about 8 to 16 hours.

6. The method as recited in claim 1, wherein in the milling step, the solid precursor is milled by zirconium ball in a milling tank for about 2 to 4 hours to form the powder precursor.

7. The method as recited in claim 1, wherein in the calcining step, the powder precursor is heated in a high temperature furnace at a temperature between 500° C. to 1000° C. for about 1 to 3 hours in the presence of ammonia gas to form the cathode catalyst.

8. An ozone generating device, comprising:
a cation exchange membrane;
an anode reservoir having an anode formed on a face of the cation exchange membrane and arranged proximate to a side of the cation exchange membrane, the anode including an anode substrate and an anode catalyst layer coating on the anode substrate; and
a cathode reservoir having a cathode formed on the other face of the cation exchange membrane and arranged proximate to the other side of the cation exchange membrane, and the cathode including a cathode substrate having the cathode catalyst made by the method of claim 1 and a cathode catalyst layer coating on the cathode substrate;

9. The device as recited in claim 8, wherein the anode substrate is selected from the group consisting of carbon paper and carbon fabric, and the cathode substrate is selected from the group consisting of platinum, copper, silicon dioxide, lead dioxide, carbon fabric, carbon paper, and a combination thereof.

10. The device as recited in claim 8, wherein the cathode catalyst layer is formed by mixing the cathode catalyst and a resin into a paste like mixture, subsequently coating the paste like mixture on a surface of the cathode substrate, and successively drying the past like mixture.
